(19) United States
(12) Patent Application Publication
(10) Pub. No.: US 2016/0076723 A1
(43) Pub. Date: Mar. 17, 2016

(54) ROTATORY COLOR-TEMPERATURE-CHANGING DEVICE FOR VEHICLE LAMP

(71) Applicant: Chung-Chun YEN, Taichung (TW)

(72) Inventor: Chung-Chun YEN, Taichung (TW)

(21) Appl. No.: 14/951,159

(22) Filed: Nov. 24, 2015

Related U.S. Application Data
(63) Continuation-in-part of application No. 13/904,148, filed on May 29, 2013.

(51) Int. Cl. F21S 8/10

(52) U.S. Cl. CPC F21S 48/1721; F21S 48/1784

(57) ABSTRACT

A rotatory color-temperature-changing device for a vehicle lamp includes a lamp holder, a light source installed in the lamp holder, a colored lens rotatably arranged in front of the light source, and a driver connected to the colored lens so as to drive the colored lens to move between two positions. One of the positions is where the colored lens is completely hidden from the front of the light source, so that light from the light source is casted forward without any influence from the colored lens. The other position is where the colored lens totally covers the front of the light source, so that the light from the light source has its color temperature changed by the colored lens before casted forward.

This application is a continuation-in-part of U.S. patent application: Ser. No. 13/904,148 filed on May 29, 2013.

### BACKGROUND OF THE INVENTION

1. Technical Field

The present invention relates to vehicle lamps, and more particularly to a rotatory color-temperature-changing device that changes the color temperature of light of a vehicle lamp.

2. Description of Related Art

Vehicle lamps are mandatory equipment for modern vehicles for transportation safety. A known vehicle lamp typically has a lamp holder whose front side is provided with a reflective cavity for receiving a bulb. When the bulb emits light, the light is either casted forward directly or is reflected and concentrated by the reflective cavity before leaving the reflective cavity and travelling forward. The light illuminates the front of a vehicle having the lamp in a twilit condition so as to ensure safe driving.

It is known that lights having different color temperatures display different illuminative properties. For example, a light with a color temperature between 2300K and 3800K is somehow yellowish and relatively penetrative, meaning that it provides better illumination in rainy or foggy days. One the other hand, a light with a color temperature higher than 4200K is whitish and looks brighter, yet it is less penetrative and not good for rainy or foggy days. Hence, it is desired to adapt the color temperature of the light of a vehicle lamp according to different lighting needs, thereby improving driving safety.

In addition, different from stage lights and household lights, vehicle lamps are subject to strict requirement of SAE, DOT and other applicable certification systems, especially in terms of light shape and color temperature. Therefore, it is important to prevent vehicle lamps from having color mixing and light overflowing.

### SUMMARY OF THE INVENTION

One objective of the present invention is to provide a rotatory color-temperature-changing device for a vehicle lamp, which adapts the color temperature of the vehicle lamp to the ambient lighting condition.

For achieving the foregoing objective, the disclosed rotatory color-temperature-changing device comprises: a lamp holder, having a front side and a back side facing opposite to the front side, the front side being formed with a reflective cavity that has an opening, and the reflective cavity receiving a light source installed therein; a fixing seat, being located at the front side of the lamp holder and having an opaque rear panel that covers a lower part of the opening so that an upper part of the opening that is not covered by the rear panel forms a light outlet, wherein the lower part is proximately a half of a total area of the opening, the fixing seat further having a first pivotal portion; a colored lens, being arranged in front of the rear panel and having a second pivotal portion, the second pivotal portion being pivotally connected to the first pivotal portion with a pivotal axis thereof parallel to the rear panel, wherein the colored lens is transparent, and the colored lens is larger than the light outlet in terms of area; and a driver, being installed in the fixing seat and connected to the colored lens for driving the colored lens to rotate with respect to the rear panel.

With the disclosed rotatory color-temperature-changing device, a user is enabled to operate the driver to displace the colored lens with respect to the rear panel, so as to either hide the colored lens in front of the rear panel or expose the colored lens outside the rear panel, whereby when the rear panel is in front of the rear panel, light is casted to the front of the lamp holder by the light source without passing through the colored lens, and when the colored lens is exposed outside the rear panel, the light outlet is fully covered by the colored lens and the light of the light source is casted to the front of the lamp holder with its color temperature changed due to filtration caused by the colored lens it just passed through. In this way, the color temperature of the light of a vehicle lamp can be adapted to the ambient lighting condition.

### BRIEF DESCRIPTION OF THE DRAWINGS

FIG. 1 is a perspective view of a rotatory color-temperature-changing device according to one preferred embodiment of the present invention.

FIG. 2 is an exploded view of the device of FIG. 1.

FIG. 3 through FIG. 6 are schematic illustrations explaining application of the device of FIG. 1.

### DETAILED DESCRIPTION OF THE INVENTION

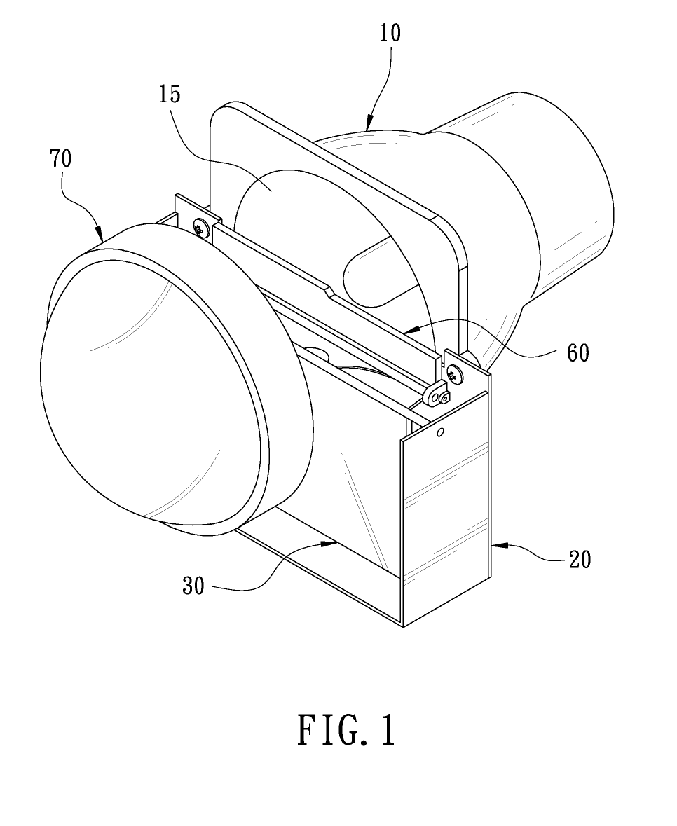

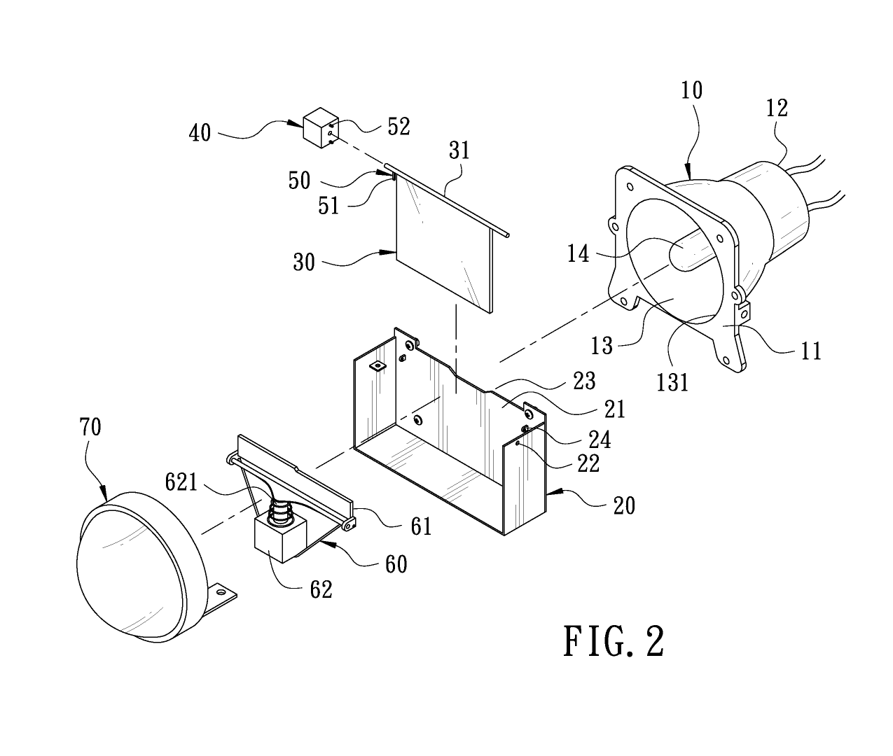

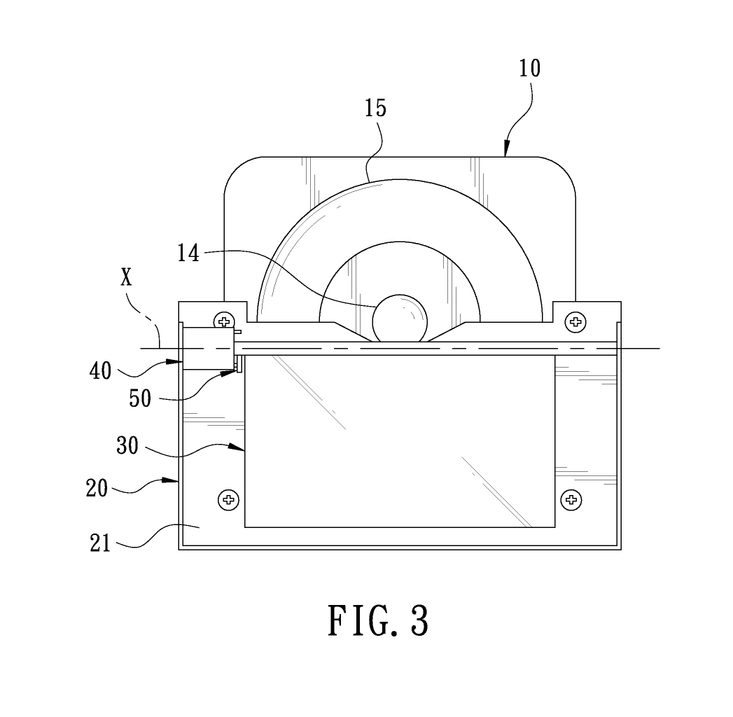

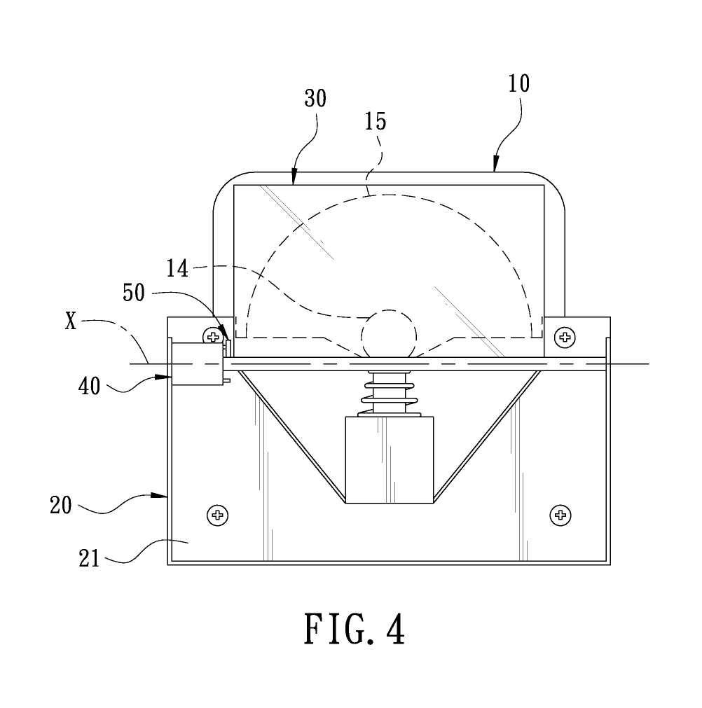

Please refer to the perspective view (FIG. 1), the exploded view (FIG. 2) and applied views (FIG. 3 and FIG. 4) for a rotatory color-temperature-changing device according to one preferred embodiment of the present invention that comprises a lamp holder 10, a fixing seat 20, a colored lens 30, a driver 40, a limit unit 50, a high/low-beam switching unit 60, and a fisheye lens 70.

The lamp holder 10 has a front side 11 and a back side 12 facing opposite to the front side 11. The lamp holder 10 has a reflective cavity 13 formed at the front side 11, and the reflective cavity 13 has an opening 131. A light source 14 is installed in the reflective cavity 13.

The fixing seat 20 is located at the front side 11 of the lamp holder 10. The fixing seat 20 has an opaque rear panel 21. The rear panel 21 covers the lower part of the opening 131, so that the upper part of the opening 131 that is not covered by the rear panel 21 forms a light outlet 15. The lower part that is covered by the rear panel 21 is approximately a half of a total area of the opening 131. The fixing seat 20 further has a first pivotal portion 22. In the present embodiment, the first pivotal portion 22 is a through hole. The rear panel 21 has its top edge provided with a gap 23 corresponding to the light outlet 15, and has a plurality of supports 24 near the gap 23.

The colored lens 30 is arranged in front of the rear panel 21. The colored lens 30 has a second pivotal portion 31. In the present embodiment, the second pivotal portion 31 is a pivot that has one end thereof rotatably received in the through hole, so that the second pivotal portion 22 is pivotally connected to the first pivotal portion 31 with a pivotal axis X thereof parallel to the rear panel 21. The colored lens 30 is transparent and the colored lens 30 is larger than the light outlet 15 in terms of area.

The driver 40 is installed in the fixing seat 20 and is connected to the colored lens 30 so as to drive the colored lens 30 to rotate with respect to the rear panel 21. Referring to FIG. 3, the colored lens 30 may be completely hidden in front of the rear panel 21, so that when the light is casted by light source 14 in front of the lamp holder 10 without passing through the colored lens 30. In an alternative case, as shown in FIG. 4, the colored lens 30 rotates to a position where it is exposed outside the rear panel 21 and fully covers the light outlet 15. At this time, the light from the light source 14 first passes through and gets filtered by the colored lens 30 and then travels forward and leaves the lamp holder 10, so the resultant light has its color temperature changed. In the present embodiment, the driver 40 is a motor that is directly connected to the pivot.

The limit unit 50 is provided on the colored lens 30 for limiting a rotating angle of the colored lens 30. In the present embodiment, the limit unit 50 comprises a first limit block 51 formed on the colored lens 30 and a plurality of second limit blocks 52 separately arranged at the periphery of the driver 40, so that the first limit block 51 is located between the second limit blocks 52.

The high/low-beam switching unit 60 is located between the rear panel 21 and the colored lens 30, and has a blocking plate 61 located in front of the gap 23. The blocking plate 61 is connected to a control 62 that drives the blocking plate 61 to rotate with respect to the rear panel 21, thereby the blocking plate 61 being hidden in front of the rear panel 21 or being set to cover the gap 23. In the present embodiment, the blocking plate 61 is pivotally connected between the supports 24, so that the blocking plate 61 is allowed to rotate with respect to the rear panel 21. The control 62 is a solenoid valve that has an extension rod 621. The extension rod 621 has its free end connected to the blocking plate 61.

The fisheye lens 70 is arranged in front of the fixing seat 10, for concentrating the light emitted by the light source 14 before the light is casted out of the lamp holder 10, thereby preventing light scattering and thereby securing a desired light shape.

Referring to FIG. 3, in the normal state, when the light source emits light, the light directly travels forward and leave the lamp holder or gets concentrated by the reflective cavity 13 and then casted out of the lamp holder 10. At this time, since the colored lens 30 is fully hidden in the front of the rear panel 21, with the shelter provided by the rear panel 21, the light does not contact the colored lens 30 at all, so its color temperature is prevented from getting changed by the colored lens 30.

Now referring to FIG. 4, when it is desired to change the color temperature of the light of the vehicle lamp, by turning on the driver 40, the driver 40 drives the colored lens 30 to rotate with respect to the rear panel 21. At this time, the colored lens 30 is fully exposed outside the rear panel 21 to fully cover the light outlet 15. As a result, the light from the light source 14 as a whole passes through the colored lens 30 and has its color temperature changed, before being casted out of the lamp holder 10. Thereby, the color temperature of the light can be adjusted depending on the ambient lighting condition.

An example is described below for further explanation. In the example, the light source 14 is a high-intensity discharge bulb generating a color temperature of 6500K, and the colored lens 30 is a yellow lens. The combination allows a vehicle lamp equipped with the rotatory color-temperature-changing device to either normally provide bright illumination, or cast out the light having its color temperature forcedly changed by the exposed colored lens 30 to a range between 2300K and 3800K that is more penetrative when it rains or turns misty, thereby ensuring driving safety.

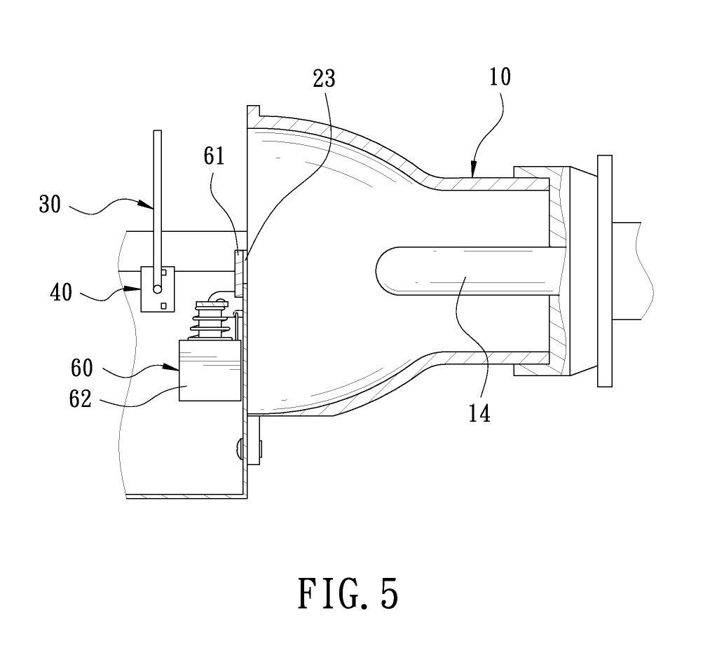

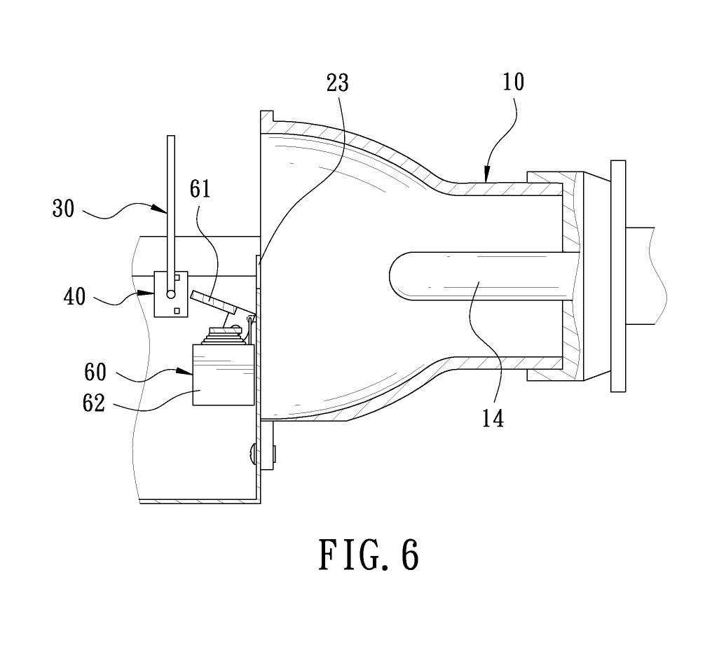

Referring to FIG. 5 and FIG. 6, the high/low-beam switching unit 60 operates the control 62 to drive the blocking plate 61 to rotate with respect to the rear panel 21. In FIG. 5, the blocking plate 61 covers the gap 23, and in FIG. 6, the blocking plate 61 is hidden in front of the rear panel 21 so that the gap 23 is not covered, thereby switching the lamp between a low beam and a high beam. Since the principle on which the high/low-beam switching unit works is known in the art, no further description in detail is provided herein. However, it is to be noted that in the present invention the colored lens 30 is located in front of the high/low-beam switching unit 60, the colored lens 30 can selectively changes the color temperature of the light from the lamp regardless the lamp provides the low beam or the high beam. In other words, the present invention is applicable to a vehicle lamp having the high/low-beam switching unit 60.

It is to be highlighted that since a vehicle lamp is subject to strict requirements about its light shape and color temperature and shall not have color mixing or light overflowing, the present invention uses the features that the rear panel 21 provides full coverage, and that the colored lens 30 is larger than the light outlet 15 to allow the colored lens 30 to be fully hidden in the front of the rear panel 21 or to fully cover the light outlet 15, thereby providing either entirely unfiltered light or entirely filtered light. In this way, both color mixing and light overflowing can be prevented and thus legal compliance can be ensured.

Different from other lamps, vehicle lamps are relatively compact and especially restricted in the transverse direction. This means if the colored lens 30 otherwise moves transversely, a conventional vehicle lamp would have to be significantly changed in terms of structure. For preventing this problem, the present invention makes the pivotal axis X of the colored lens 30 parallel to the rear panel 21. This design allows the colored lens 30 to rotate forward or back, and is therefore receivable in the originally reserved space between the fisheye lens 70 and the in fixing seat 20 of a common vehicle lamp, without significantly changing the structure of the existing lamps.

What is claimed is:

1. A rotatory color-temperature-changing device for a vehicle lamp, comprising:
a lamp holder, having a front side and a back side facing opposite to the front side, the front side being formed with a reflective cavity that has an opening, and the reflective cavity receiving a light source installed therein;
a fixing seat, being located at the front side of the lamp holder and having an opaque rear panel that covers a lower part of the opening so that an upper part of the opening that is not covered by the rear panel forms a light outlet, wherein the lower part is proximately a half of a total area of the opening, the fixing seat further having a first pivotal portion;
a colored lens, being arranged in front of the rear panel and having a second pivotal portion, the second pivotal portion being pivotally connected to the first pivotal portion with a pivotal axis thereof parallel to the rear panel, wherein the colored lens is transparent, and the colored lens is larger than the light outlet in terms of area; and
a driver, being installed in the fixing seat and connected to the colored lens for driving the colored lens to rotate with respect to the rear panel so as to either hide the colored lens in front of the rear panel or expose the colored lens outside the rear panel, whereby when the rear panel is in front of the rear panel, light is casted to the front of the lamp holder by the light source without passing through the colored lens, and when the colored lens is exposed outside the rear panel, the light outlet is fully covered by the colored lens and the light of the light source is casted to the front of the lamp holder with its color temperature changed due to filtration caused by the colored lens it just passed through.

2. The rotatory color-temperature-changing device of claim 1, wherein the first pivotal portion is a through hole and the second pivotal portion is a pivot.

3. The rotatory color-temperature-changing device of claim 2, wherein the pivot has one end thereof received in the through hole and an opposite end connected to the driver.

4. The rotatory color-temperature-changing device of claim 3, wherein the driver is a motor that is directly connected to the pivot.

5. The rotatory color-temperature-changing device of claim 1, wherein the rear panel has a gap at its top edge corresponding to the light outlet, the rotatory color-temperature-changing device further having a high/low-beam switching unit located between the rear panel and the colored lens, and a blocking plate arranged in front of the gap, in which the blocking plate is connected to a control that drives the blocking plate to rotate with respect to the rear panel, so as to hide or expose the blocking plate.

6. The rotatory color-temperature-changing device of claim 5, wherein the rear panel is provided with a plurality of supports near the gap, so that the blocking plate is rotatably supported by and between the supports and allowed to rotate with respect to the rear panel.

7. The rotatory color-temperature-changing device of claim 6 wherein the control is a solenoid valve that has an extension rod whose free end is connected to the blocking plate.

8. The rotatory color-temperature-changing device of claim 1, further comprising a fisheye lens arranged in front of the fixing seat.

9. The rotatory color-temperature-changing device of claim 1, further comprising a limit unit provided on the colored lens for limiting a rotating angle of the colored lens.

10. The rotatory color-temperature-changing device of claim 9, wherein the limit unit has a first limit block provided on the colored lens and has a plurality of second limit blocks formed separately at a periphery of the driver, so that the first limit block is located among the second limit blocks.
